(19) United States
(12) Patent Application Publication
(10) Pub. No.: US 2008/0080081 A1
(43) Pub. Date: Apr. 3, 2008

(54) Magnetic read/write head inspecting method

(75) Inventor: Endo Toshihiko, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/878,815

(22) Filed: Jul. 27, 2007

(30) Foreign Application Priority Data
Sep. 28, 2006 (JP) 2006-265181

(51) Int. Cl. G11B 27/36; G11B 5/33

(52) U.S. Cl. 360/31; 360/324

(57) ABSTRACT

A method for inspecting a magnetic read/write head in which a magnetic recording part and a magnetic reproducing part are close to each other includes the steps of performing a magnetic recording operation with a load greater than a normal magnetic recording operation for the magnetic recording part, and inspecting the magnetic reproducing part after the magnetic recording operation with the load.

This application claims the right of a foreign priority based on Japanese Patent Application No. 2006-265181, filed on Sep. 28, 2006, which is hereby incorporated by reference herein in its entirety as if fully set forth herein.

### BACKGROUND OF THE INVENTION

The present invention relates generally to an inspection method, and more particularly to an inspection method of a magnetic read/write head that has a magnetic recording part (read device) and a magnetic reproducing part (write device). The present invention is suitable, for example, for an inspection method of a magnetic read/write head that includes a highly sensitive read head, such as a giant magnetoresistive (“GMR”) head device, and a tunneling magnetoresistive (“TMR”) head device, used for a hard disc drive (“HDD”).

Along with the recent widespread Internet, etc., providing of an inexpensive magnetic disc drive that stably records and reproduces a large amount of information including still and motion pictures is increasingly demanded. When the surface recording density is increased so as to meet the large-capacity demand, the 1-bit area on the recording medium reduces, and the signal magnetic field from the recording medium becomes weaker. In order to read this weak signal magnetic field, a small and highly sensitive read head is needed.

For this read head, a GMR head device and a TMR head device are known. Conventionally, a read performance test of the read device is performed based on its electromagnetic conversion characteristic, and the entire HDD operation is tested after the read head is mounted on the HDD to confirm the HDD's operational performance.

Prior art include, for example, Japanese Patent Application, Publication No. (“JP”) 2005-93054.

An environmental test is performed before the HDD is shipped to check if the HDD is non-defective or defective. The environmental test inspects its characteristics, for example, by placing the HDD under a temperature higher than the room temperature or under external loads. With a miniaturization of the highly sensitive read head, the read characteristic is likely to deteriorate due to the external loads, such as a magnetic field, heat (temperature), and electric waves. Disadvantageously, these external loads lower the yield of the HDD. JP 2005-93054 performs an external load test after the HDD is mounted with the read device, but the yield of the HDD is expected to improve if the read device that cannot maintain predetermined durability to the external loads is removed from candidates to be mounted onto the HDD. However, a new dedicated external load testing machine would increase the cost of the HDD and destroy the demand for providing an inexpensive HDD.

### BRIEF SUMMARY OF THE INVENTION

Accordingly, the present invention is directed to an inspection method for providing a magnetic reproducing part with a reduced deterioration to the external load.

A method according to one aspect of the present invention for inspecting a magnetic read/write head in which a magnetic recording part and a magnetic reproducing part are close to each other includes performing a magnetic recording operation with a load greater than a normal magnetic recording operation for the magnetic recording part, and inspecting the magnetic reproducing part after the magnetic recording operation with the load. This inspection method utilizes that a close arrangement between the magnetic recording part and the magnetic reproducing part, and the magnetic recording part applies the external load to the magnetic reproducing part. Due to the magnetic recording operation that applies a load greater than the normal magnetic recording operation, the operational reliability is secured in the normal magnetic recording operation. In addition, the conventional magnetic recording part applies the external load without providing new means of applying the external load, preventing the inspection cost increase. The magnetic recording part and the magnetic reproducing part are close to each other in the magnetic read/write head when the distance between them is, for example, 5 μm, although the present invention does not limit the distance as long as the magnetic recording part can apply the external load to the magnetic reproducing part.

The inspecting step inspects the voltage of the magnetic reproducing part when a constant current is flowed in the magnetic reproducing part. The load may be to flow current greater than rated current to be flowed in the magnetic recording part, to continuously write of a maximum write frequency, or to continuously write for at least one round of a magnetic recording medium to be recorded and reproduced by the magnetic read/write head.

A test method according to another aspect of the present invention of a read device of a head that includes the read device that reads information from a disc, and a write device that writes the information in the disc includes the step of detecting a read characteristic of the read device while the write device applies a load to the read device before the head is mounted on a storage. According to the test method, the detecting step applies the external load to the read device in detecting the read characteristic of the read device. The conventional head testing machine has a first function that detects a read characteristic of the read device under no load applied by the external load, and a second function that detects a write characteristic of the write device under no external load. The second function can control a magnitude of the current to be flowed in the write device, a frequency of the current, and the number of writes. It is not a large variation for the conventional testing machine to simultaneously exhibit the second function during exhibiting of the first function. An application of the external load by the write device utilizes the second function that is inherent to the conventional testing machine. Setting of the third mode requires merely a small program or software modification of the conventional testing machine, and does not require a new machine, preventing the test cost increase. Moreover, this test method can improve the yield of the HDD further than JP 2005-93054, since it performs the test before the head is mounted on the HDD.

A method according to another aspect of the present invention for manufacturing a storage that includes a head that includes the read device that reads information from a disc, and a write device that writes the information in the disc includes the steps of detecting a read characteristic of the read device while the write device applies a load to the read device before the head is mounted on the storage, determining whether the read characteristic of the read device detected by the detecting step falls within a permissible range, and selecting as a candidate to be mounted onto the storage the read device having the read characteristic that falls within the permissible range. The manufacturing method mounts on the storage only the read device determined by the determining step to have a predetermined read characteristic, improving the yield of the storage. The above detecting step can restrain the remarkable manufacturing cost increase of the storage.

A manufacturing method according to another aspect of the present invention a storage that includes a head that includes the read device that reads information from a disc, and a write device that writes the information in the disc includes a first detecting step of detecting a read characteristic of the read device under no load applied by the write device to the read device before the head is mounted on the storage, a second detecting step of detecting the read characteristic of the read device under a load applied by the write device to the read device before the head is mounted on the storage, determining whether a deterioration of the read characteristic of the read device detected by the second detecting step relative to the read characteristic of the read device detected by the first detecting step falls within a permissible range, and selecting as a candidate to be mounted onto the storage the read device having the read characteristic that falls within the permissible range. The manufacturing method mounts on the storage only the read device determined by the determining step to have a predetermined read characteristic, improving the yield of the storage. The above detecting step can restrain the remarkable manufacturing cost increase of the storage.

The load is, for example, a magnetic load and/or a thermal load. The detecting step of the second detecting step may set at least one of a magnitude of current to be flowed in the write device, a frequency of the current, and the number of writes to a value greater than a maximum value in an actual use mode used to actually write the information in the disc. If necessary, it is possible to further control an overshoot of the leading edge of the current, the polarity of the current, and the frequency pattern (i.e., whether it is a continuous pattern or a random pattern).

A program according to another aspect of the present invention that enables a computer to implement a manufacturing method of a storage that includes a head that includes the read device that reads information from a disc, and a write device that writes the information in the disc includes the steps of determining whether a deterioration of the read characteristic of the read device under a load applied by the write device to the read device to the read characteristic under no load applied by the read device falls within a permissible range, and outputting a determination result by the determining step while correlating the determination result with an identification of the head. This program assists in sorting the defective and non-defective heads.

A testing machine according to another aspect of the present invention of a head that includes the read device that reads information from a disc, and a write device that writes the information in the disc includes a first mode used to detect a read characteristic of the read device under no load applied by the write device before the head is mounted on the storage, a second mode used to detect a write characteristic of the write device before the head is mounted on the storage, and a third mode used to detect the read characteristic of the read device under a load applied by the write device to the read device before the head is mounted on the storage. This testing machine has the third mode that is not inherent to the conventional testing machine, but the third mode is a modification of the first and second modes and a mere software modification is sufficient. Therefore, a large design change of the conventional testing machine is unnecessary.

Preferably, the testing machine further include a controller that determines whether a deterioration of the read characteristic of the read device under the load applied by applied by the write device to the read device to the read characteristic of the read device under no load applied by the write device falls within a permissible range before the head is mounted onto the storage. Moreover, the controller outputs the test determination result while correlating it with the ID of the head.

Other objects and further features of the present invention will become readily apparent from the following description of the preferred embodiments with reference to accompanying drawings.

### BRIEF DESCRIPTION OF THE DRAWINGS

FIG. 1 is a schematic plane view of a testing machine according to one embodiment of the present invention.

FIG. 2 is a flowchart for explaining a manufacturing method according to one embodiment of the present invention.

FIG. 3 is a flowchart for explaining details of the step 1000 shown in FIG. 2.

FIG. 4 is a flowchart for explaining details of the step 1100 shown in FIG. 3.

FIG. 5 is a flowchart for explaining details of the step 1200 shown in FIG. 3.

FIG. 6 is a flowchart for explaining details of the step 1300 shown in FIG. 3.

FIG. 7A is a graph showing a result of the step 1000 shown in FIG. 3, and FIG. 7B is a graph of a read device that passes the test of the step 1000 shown in FIG. 3.

FIG. 8 is a plane view of an HDD to which a head gimbal assembly (“HGA”) shown in FIG. 1 is mounted.

FIG. 9 is perspective and partially enlarged perspective views showing details of a magnetic head part shown in FIG. 8, and a schematic sectional view of the head.

FIG. 10 is a schematic enlarged plane view of the magnetic head part shown in FIG. 9.

FIG. 11 is top, side and rear views of the HGA shown in FIG. 1.

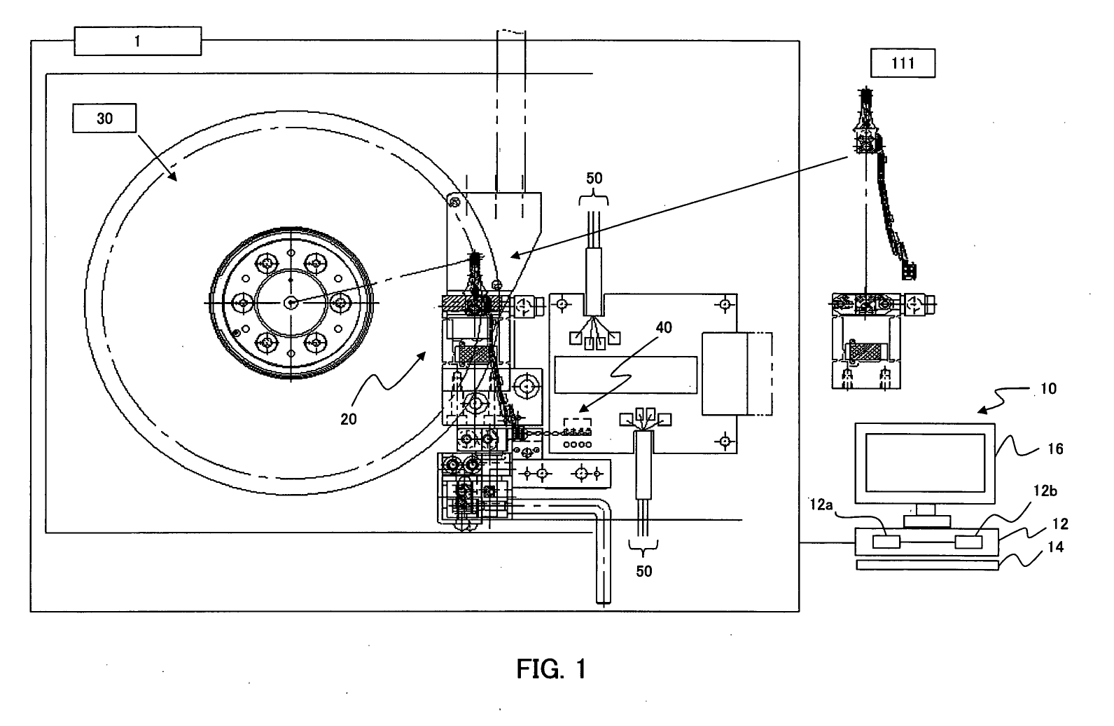

### DETAILED DESCRIPTION OF THE PREFERRED EMBODIMENTS

Referring now to the accompanying drawings, a description will be given of a testing machine 1 for a magnetic head used for a HDD (storage) 100, which will be described later. The testing machine includes a personal computer (“PC”) 10, and a mounting part 20 that is mounted with a head gimbal assembly (“HGA”) 111, a disc (recording medium) 30, a detector 40, and a pair of current supply units 50. The HGA 111 is a suspension assembly mounted with a slider, and also referred to as a head suspension assembly.

The testing machine 1 inspects whether the HGA 111 is non-defective or defective before the HGA 111 is mounted on the HDD 100. The HGA 111 is mounted with a magnetic head part 120, as described later, and the magnetic head part 120 is includes a write device (or inductive head device 130, which will be described later) that writes information in the disc, and a read device (or MR head device 140, which will be described later) that reads information from the disc 104. The testing machine 1 tests the read device and the write device to check if they are non-defective or defective, and outputs the result while correlating their IDs.

The PC 10 controls an operational mode of the testing machine 1, and outputs and stores a test result. Although the PC 10 is part of the testing machine 1, another embodiment connects the PC 10 with the testing machine 1 through a network.

The PC 10 includes a PC body 12, an input part 14, such as a keyboard and a mouse, and an output part 16, such as a display. The PC body 12 includes a controller 12a, such as a CPU, and a memory 12b that stores a test or manufacture method of this embodiment.

The testing machine 1 includes first to third modes as operational modes. The operational mode of the testing machine 1 does not change whether the PC 10 is part of the testing machine 1 or connected to the testing machine 1 via the network. Each mode is implemented as a software program, and stored in the memory 12b. A user can select one of the modes through the input part 14 and the controller 12a while viewing the output part 16.

The first mode detects, before the HGA 111 is mounted on the HDD 100, a read characteristic of the read device while applying no load from the write device to it. The second mode detects, before the HGA 111 is mounted on the HDD 100, a write characteristic of the write device. The third mode detects, before the HGA 111 is mounted on the HDD 100, the read characteristic of the read device while applying a load from the write device to it.

The mounting part 20 is mounted with the HGA 111. While the HGA 111 is mounted on the mounting part 20, the read device of the HGA 111 reads information out of the disc 30 and sends it to the detector 40. The information detected by the detector 40 (or an output voltage value of the read device) is sent to the controller 12a in the PC 10. While the HGA 111 is mounted onto the mounting part 20, the controller 12a of the PC 10 controls the current supply units 50 to supply a frequency pattern of the current to the write device, and the write device writes the information in the disc 30.

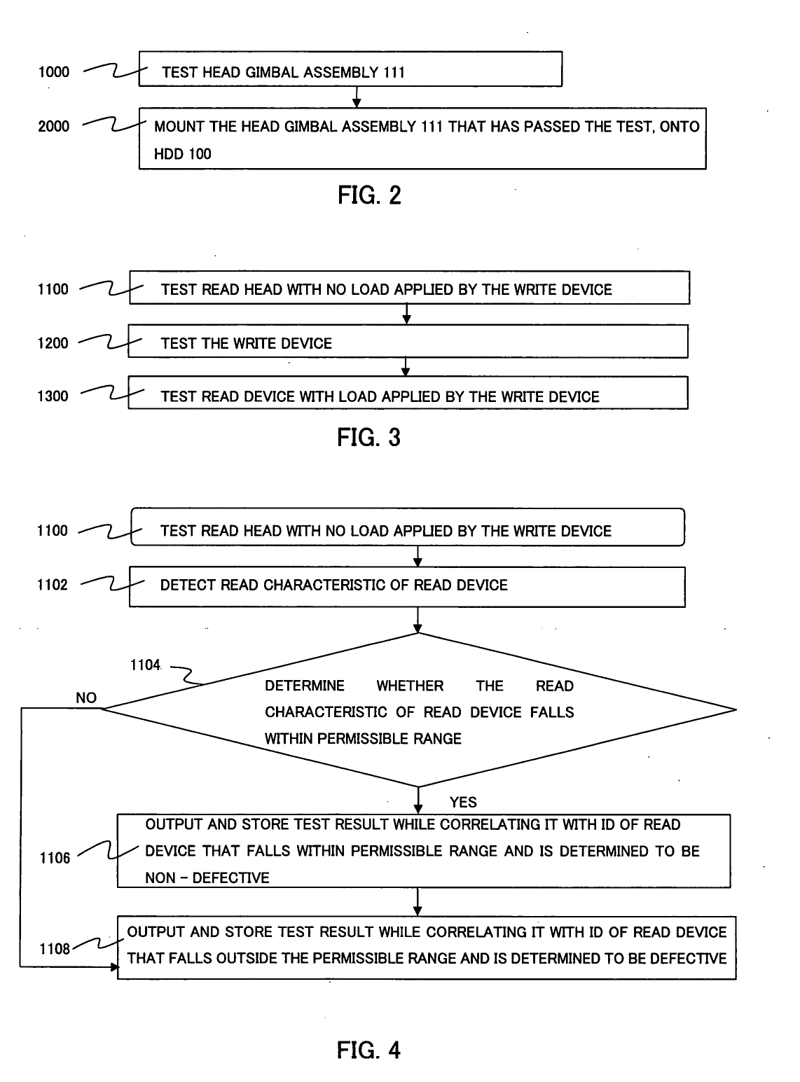

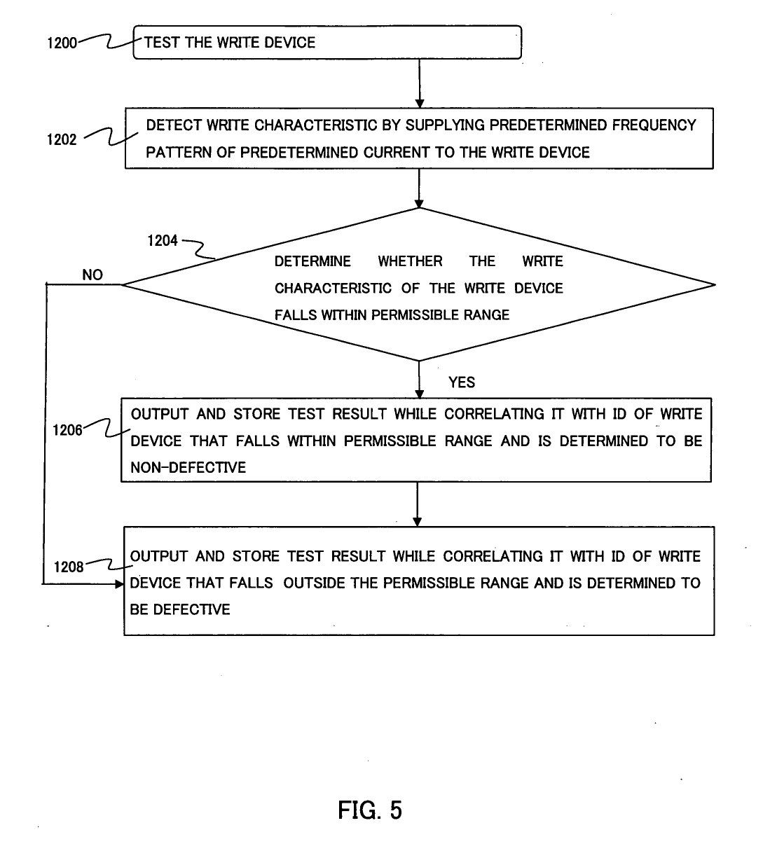

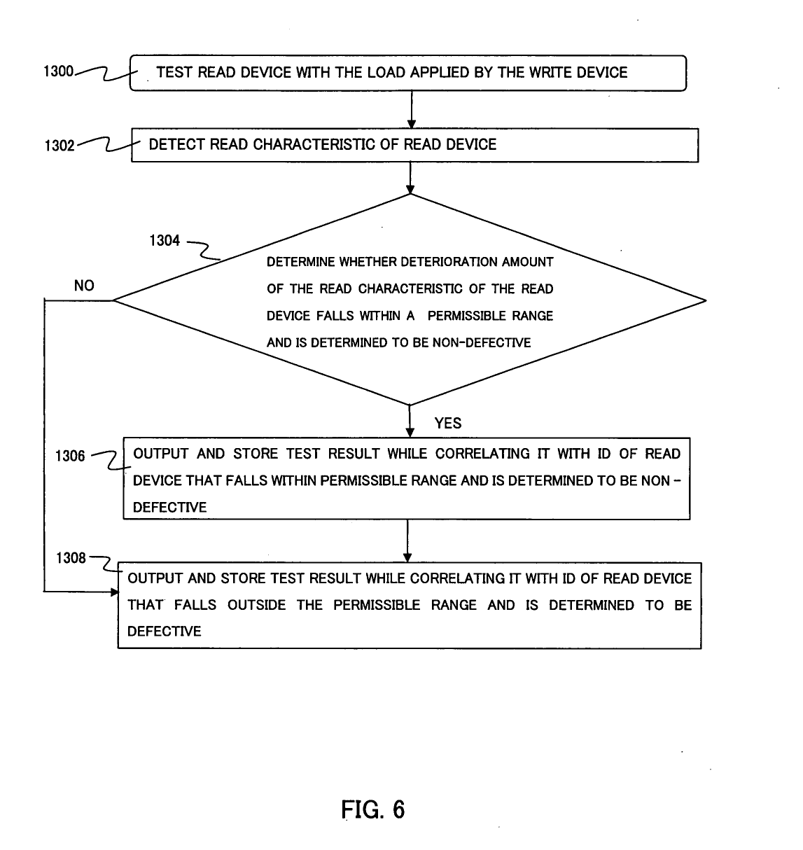

Referring now to FIGS. 2 to 6, a description will be given of an operation of the testing machine 1. Here, FIG. 2 is a flowchart for explaining a manufacturing method of the HDD 100 according to this embodiment. FIG. 3 is a flowchart for explaining details of the step 1000 shown in FIG. 2. FIG. 4 is a flowchart for explaining details of the step 1100 shown in FIG. 3. FIG. 5 is a flowchart for explaining details of the step 1200 shown in FIG. 3. FIG. 6 is a flowchart for explaining details of the step 1300 shown in FIG. 3.

Referring to FIG. 2, the controller 12a tests the HGA 111 (step 1000). The controller 12a selects successful candidates of the test among the HGAs 111 as candidates to be mounted on the HDD 100 (step 2000). According to this manufacturing method, the controller 12a mounts only the read device that is determined to have little deterioration onto the HDD 100 in the step 1304, which will be described later, in the step 1000. The entire HDD 100 is subject to an environmental test, such as a temperature test, but the step 1300 has already selected the HGA 111 mounted on the HDD 100 which has little deterioration, improving the yield of the HDD 100 further than JP 2005-93054. Referring now to FIGS. 3 to 6, a description will be given of the step 1000.

Referring to FIG. 3, initially, the read device is tested under no load applied to the write device (step 1100). As a result, only the read device that has passed the test is used for the step 1300. Similarly, the write device is tested with no load (step 1200). As a result, only the write device that has passed the test is used for the step 1300. Next, the read device is tested with a load applied by the write device (step 1300). As a result, the HGA 111 that has passed the test is mounted as a non-defective article onto the HDD 100. The test method of this embodiment has the step 1300 unlike the conventional test method.

The step 1100 is an operation of the first mode that is also inherent to the conventional testing machine. Referring to FIG. 4, the step 1100 first detects the read characteristic of the read device (or an output of the read device) with no load applied by the write device (step 1102). Next, the controller 12a determines whether the read characteristic of the read device falls within a permissible range (step 1104). The permissible range is stored in the memory 12b. The permissible range of this embodiment is a range of ±20% of an ideal output value of the read device, but this is for merely illustrative purposes. The controller 12a determines that a read device having the read characteristic that falls within the permissible range is non-defective (step 1106), and that a read device having the read characteristic that falls outside the permissible range is defective (step 1108). The controller 12a outputs the test result while correlating it with an ID of the read device to the output part 16, and stores it in the memory 12b. Only the read device that has passed the test is used for the step 1300. As a result, even when the condition of the step 1300 is met, the read device that does not satisfy the step 1100 is removed.

The step 1200 is an operation of the second mode that is also inherent to the conventional testing machine. Referring to FIG. 5, the step 1200 first detects the write characteristic of the write device by supplying the predetermined current with a predetermined frequency pattern to the write device (step 1202). Next, the controller 12a determines whether the write characteristic of the write device falls within a permissible range (step 1204). The permissible range is stored in the memory 12b. The permissible range of this embodiment is a range of ±20% of an ideal output value of the write device, but this is for merely illustrative purposes. The controller 12a determines that the write device having the write characteristic that falls within the permissible range is non-defective (step 1206), and that the write device having the write characteristic that falls outside the permissible range is defective (step 1208). The controller 12a outputs the test result while correlating it with an ID of the write device to the output part 16, and stores it in the memory 12b. Only the write device that has passed the test is used for the step 1300. As a result, the properly operable write device is used for the step 1300.

The step 1300 is an operation of the third mode that is not inherent to the conventional testing machine. Referring to FIG. 6, the step 1300 first detects the read characteristic of the read device (or an output of the read device) with a load applied by the write device (step 1302). The testing machine 1 performs a magnetic recording operation so that the applied load becomes a load greater than the normal magnetic recording operation. Next, the controller 12 determines whether a deterioration amount of the read characteristic of the read device before and after the write device applies the load falls within a permissible range (step 1304). The permissible range is stored in the memory 12b. The permissible range of this embodiment is a range of ±20% of an ideal value of a ratio between the read characteristic of the read device after the write device applies no load to the read characteristic of the read device before the write device applies the load. However, this is for merely illustrative purposes. Since the ideal value is 1, the permissible range is between 0.8 and 1.2. The controller 12a determines that the read device having the read characteristic that falls within the permissible range is non-defective (step 1306), and that the read device having the read characteristic that falls outside the permissible range is defective (step 1308). The controller 12a outputs the test result while correlating it with an ID of the read device to the output part 16, and stores it in the memory 12b.

The step 1302 applies the external load to the read device in detecting the read characteristic of the read device. The conventional testing machine has only the first and second mode, and the controller 12a can control the current's magnitude and frequency and the number of writes in the write device. It is not a large variation for the testing machine 1 to simultaneously exhibit part of the operation of the second mode during the first mode. An application of the external load by the write device utilizes the first and second modes that are inherent to the conventional testing machine. Setting of the third mode requires merely a small program or software modification of the first and second modes in the conventional testing machine, and does not require a new machine. Therefore, the test cost increase can be prevented even when the third mode is added. Since the write device is very closely arranged to the read device, the write device can be used for the external load source to the read device. Moreover, this test method tests before the HGA 111 is mounted on the HDD 100. Although the entire HDD 100 also undergoes the external test, such as the temperature test, this embodiment can improve the yield of the HDD 100 further than JP 2005-93054, since the selected HGA 111 mounted on the HDD 100 has little environmental deterioration.

The external loads contain a magnetic field, heat, and radio waves. The load which the write device applies in this embodiment is the magnetic load and/or the thermal load. The magnetic load and the thermal load are influential factors in the external loads that affect the read device. The magnetic load and/or the thermal load intend to mean the magnetic load, the thermal load, and the magnetic and thermal loads. For example, if the read characteristic deteriorates with an application of only the magnetic load, a feedback is available, such as to confirm a processing state of a shield film, which will be described later.

The magnetic load or the thermal load is a load equal to or greater than a maximum value received by the read device during the normal use in the HDD 100. Control over the magnetic load and the thermal load sets at least one of the magnitude of the current to be flowed in the write device, such as constant current, the frequency of the current, and the number of writes to the maximum value in the actual mode in which information is actually written in the disc. For example, the current greater than the rated current to be flowed in the magnetic recording part is flowed in the magnetic recording part, the magnetic recording part continuously writes at the maximum writing frequency, and the magnetic recording part continuously writes for at least one round of the magnetic recording medium to be recorded and reproduced by the magnetic read/write head.

Assume that one write of the number of writes is defined once per one rotation of the disc 30. For example, when the write current is set high and the frequency of the current is set low, only the thermal (temperature) load can be enhanced. When the write current is set low and the frequency of the current is set low, the magnetic strength and the magnetic amplitude of the magnetic load can be restrained. When both the write current and the frequency of the current are set high, both the magnetic load and the thermal load can be enhanced. If necessary, the controller 12a can further control an overshoot of the leading edge of the current, the polarity of the current, and the frequency pattern (i.e., whether it is a continuous pattern or a random pattern). Thereby, fine control over the magnetic load and the thermal load is available.

The write device applies the external load to the read device with the write current of 40 ml, the frequency of the current of 500 MHz, the frequency pattern of a continuous pattern, and the number of writes of 1,000 times. The write current is about 30 ml in the actual use of the HDD 100, and increased by about 30%. The frequency of 500 MHz is the maximum frequency in the current HDD 100. A guarantee of 100 writes is sufficient in the normal HDD 100. The write current of 40 ml and the frequency of 500 MHz make the temperature of the read device 55° C. or greater. 55° C. is an upper limit value of the environmental temperature guaranteed by the HDD 100.

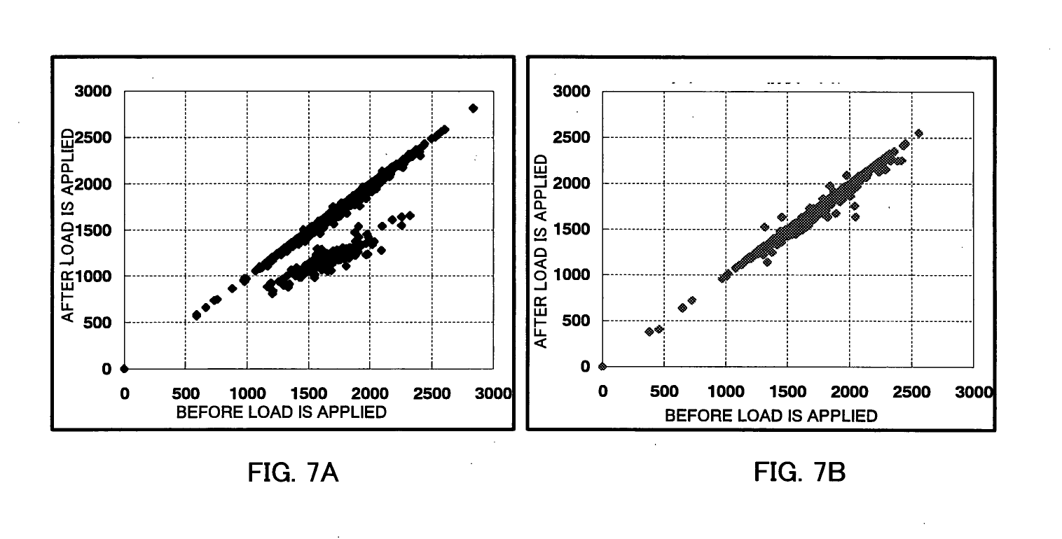

FIG. 7A shows a result where an abscissa axis denotes an output of the read device before the load is applied, and an ordinate axis denotes an output of the read device after the load is applied. In FIG. 7A, an ideal line has a gradient of 1, and the permissible range is a range ±20% from the line having the gradient of 1. The read devices enclosed by the ellipse are those outside the permissible range, and the controller 12a determines these read devices defective. FIG. 7B shows non-defective read devices. Each read device shown in FIG. 7B is mounted onto the HDD 100. Thereafter, the HDD 100 wholly undergoes the environmental test. The environmental test sets, for example, the environmental temperature to 55° C., and tests the characteristic of the HDD 100 to the environment. When a ratio at which the HDDs 100 pass the environmental test is investigated, the yield of the HDDs 100 that use the read devices shown in FIG. 7B improves by 10% to 20% in comparison with the HDDs 100 that use all the read devices including the elliptical area shown in FIG. 7A.

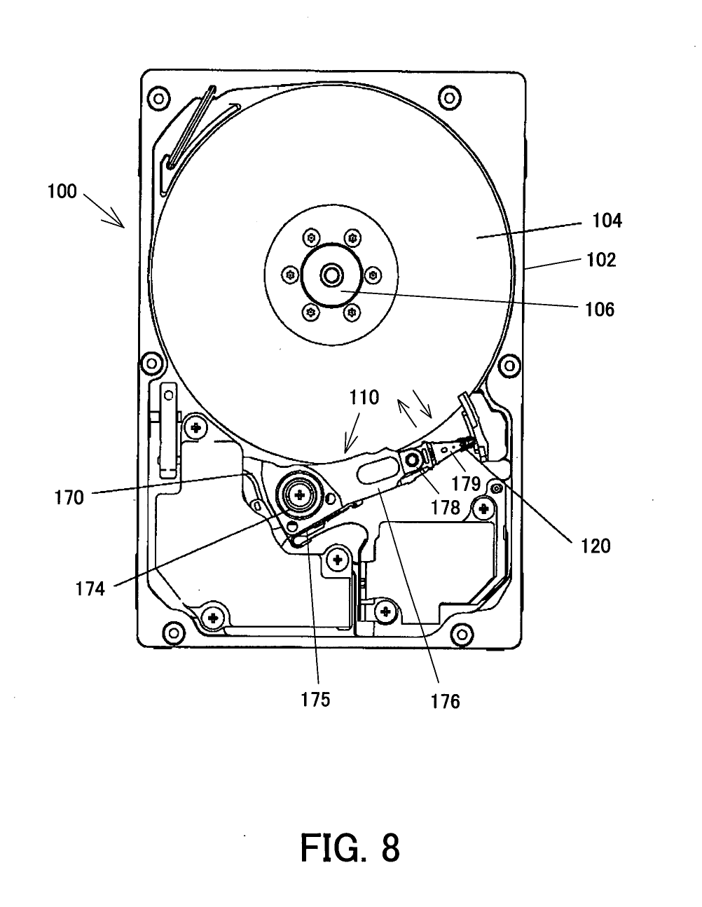

Referring now to FIGS. 8 to 11, a description will be given of the HDD 100 mounted with the HGA 111 in the step 2000 shown in FIG. 2. The HDD 100 includes, as shown in FIG. 8, one or more magnetic discs 104 each serving as a recording medium, a spindle motor 106, and a head stack assembly (“HSA”) 110 in a housing 102. HGA 111 constitutes part of the HSA 110. Here, FIG. 8 is a schematic plane view of the internal structure of the HDD 100.

The housing or base 102 is made, for example, of aluminum die cast and stainless steel, and has a rectangular parallelepiped shape to which a cover that seals the internal space is joined. The magnetic disc 104 has a high surface recording density, such as 100 Gb/in² or greater. The magnetic disc 104 is mounted on a spindle (hub) of the spindle motor 106 through its center hole of the magnetic disc 104.

The spindle motor 106 has, for example, a brushless DC motor (not shown) and a spindle as its rotor part. For instance, two magnetic discs 104 are used in order of the disc, a spacer, the disc and a clamp stacked on the spindle, and fixed by bolts coupled with the spindle.

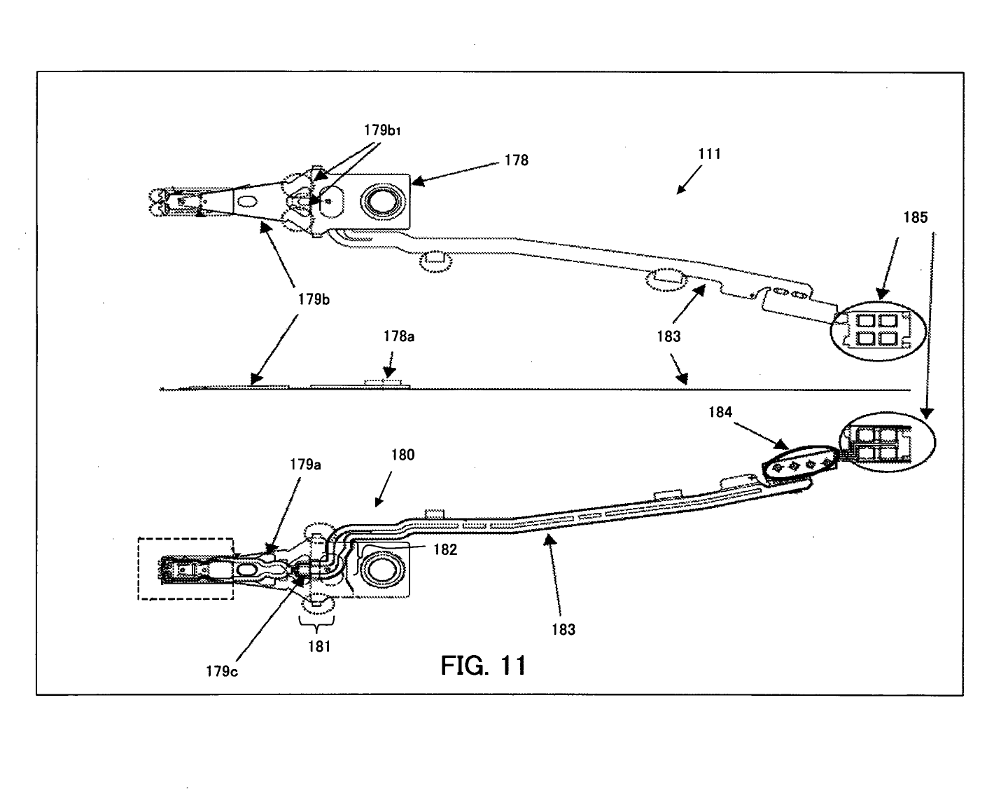

The HSA 110 includes a magnetic head part 120, a carriage 170, and a base plate 178, and a suspension 179. FIG. 11 shows top, side and rear views of the HGA 111.

The magnetic head part 120 includes a slider 121, and a read/write head 122 that is jointed with an air outflow end of the slider 121.

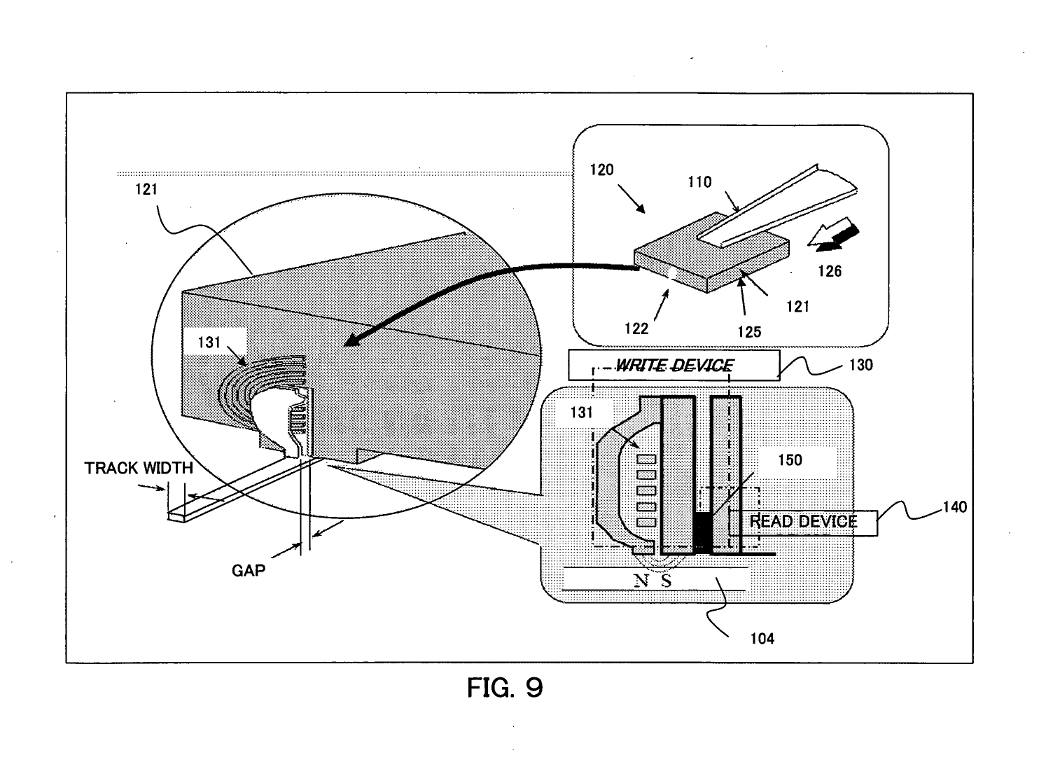

The slider 121 has an approximately rectangular parallelepiped shape, and is made of Al₂O₃—TiC (Altic). The slider 121 supports the head 122 and floats from the surface of the disc 104. The head 122 records information in and reproduces information from the disc 104. A surface of the slider 121 opposing to the magnetic disc 104 serves as a floating surface 125. The floating surface 125 receives airflow 126 that occurs with rotations of the magnetic disc 104. Here, FIG. 9 is a schematic perspective view of the magnetic head part 120.

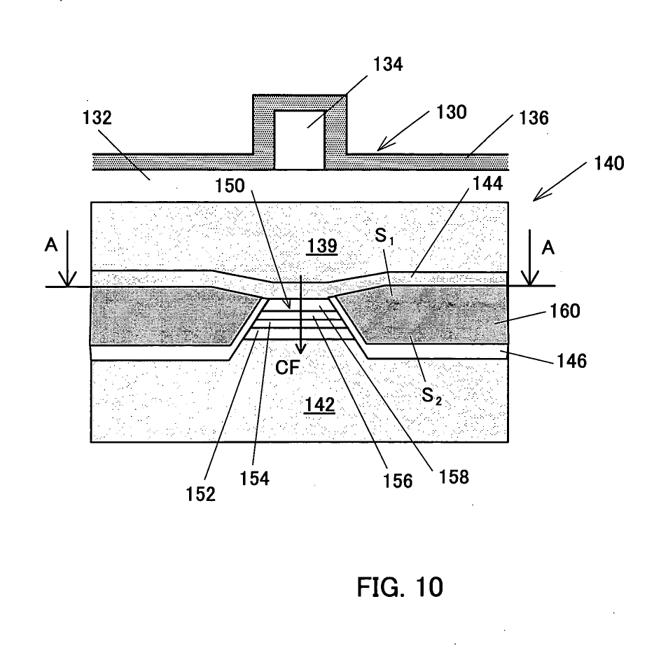

FIG. 10 is an enlarged plane view of the head 122. The head 122 is, for example, a MR inductive composite head that includes an inductive head device 130 that writes binary information in the magnetic disc 104 utilizing the magnetic field generated by a conductive coil pattern (not shown), and a magnetoresistive (“MR”) head device 140 that reads the binary information based on the resistance that varies in accordance with the magnetic field applied by the magnetic disc 104.

The inductive head device 130 includes a nonmagnetic gap layer 132, an upper magnetic pole layer 134, an insulating film 136 made of an Al₂O₃ film, and an upper shield-upper electrode layer 139. The upper shield-upper electrode layer 139 also constitutes part of the MR head device 140. The MR head device 140 includes the upper shield layer 139, a lower shield layer 142, an upper gap layer 144, a lower gap layer 146, a MR film 150, and a pair of hard bias films 160 arranged at both sides of the MR film 150. Thus, the inductive head device (magnetic recording part) 130 and the MR head device (magnetic reproducing part) 140 are arranged close to each other within a distance, for example, of 5 μm.

The MR film 150 may include, for example, a spin-valve film and a TMR film. In case of the TMR film, the MR film 150 includes, from the bottom in FIG. 10, a free ferromagnetic layer 152, a nonmagnetic intermediate layer 154, a pinned magnetic layer 156, and an antiferromagnetic layer 158. The TMR film has a ferromagnetic tunneling junction configured to hold the insulating layer 154 between the two ferromagnetic layers, and uses a tunneling phenomenon in which the electrons in the minus side ferromagnetic layer pass through the insulating layer to the plus side ferromagnetic layer, when the voltage is applied between the two ferromagnetic layers. The insulating layer 154 uses, for example, an Al₂O₃ film. In case of the spin-valve film, the MR film 150 is a CPP-GMR device, which includes, in order from the bottom shown in FIG. 10, a free layer 152, a nonmagnetic intermediate layer 154, a pinned magnetic layer 156, and an exchange-coupling (antiferromagnetic) layer 158. Usually, a protective layer and a nonmagnetic primary coat, such as Ta, are added above the exchange-coupling layer and under the free layer. The MR head device 140 of this embodiment has a CPP structure that applies the sense current perpendicular to the lamination plane or parallel to the lamination direction of the MR film 150, as shown by an arrow CF, but the present invention allows the MR device to be a CIP-GMR device.

Turning back to FIG. 8, the carriage 170 serves to rotate or pivot the magnetic head part 120 in arrow directions shown in FIG. 8, and includes a voice coil motor (“VCM”), a shaft 174, a flexible printed circuit board (“FPC”) 175, and an arm 176.

The VCM has a flat coil between a pair of yokes. The flat coil opposes to a magnetic circuit (not shown) provided to the housing 102, and the carriage 170 swings around the shaft 174 in accordance with values of the current that flows through the flat coil. The magnetic circuit includes, for example, a permanent magnet fixed onto an iron plate fixed in the housing 102, and a movable magnet fixed onto the carriage 170.

The shaft 174 is inserted into a hollow cylinder in the carriage 170, and extends perpendicular to the paper surface of FIG. 8 in the housing 102. The FPC 175 provides wiring part with a control signal, a signal to be recorded in the disc 104, and the power, and receives a signal reproduced from the disc 104.

The arm 176 is an aluminum rigid body, and has a perforation hole at its top. The suspension 179 is attached to the arm 176 via the perforation hole and the base plate 178.

The base plate 178 serves to attach the suspension 179 to the arm 176, and includes a welded section, and a hub 178a. The welded portion is laser-welded with the suspension 179. The hub 178a is a part to be swaged with the arm 176.

The suspension 179 serves to support the magnetic head part 120 and to apply an elastic force to the magnetic head part 120 against the magnetic disc 104, and is, for example, a stainless steel suspension. The suspension 179 has a flexure 179a that cantilevers the magnetic head part 120, and a load beam 179b that is connected to the base plate 178. The load beam 179b has a spring part at its center so as to apply sufficient compression force in the Z direction. The load beam 179b contacts the flexure 179a via a projection called a dimple (referred to as a pivot or another name) so that the floating surface 125 follows the disc 104's warp and swell and it is always parallel to the disc surface. The magnetic head part 120 is designed to softly pitch and roll around the dimple. The suspension 179 also supports the wiring part that is connected to the magnetic head part 120 via a lead etc.

The suspension 179 is mounted with a suspension substrate 180 connected electrically to the magnetic head part 120, as shown in FIG. 11. The suspension substrate 180 is electrically connected to the head 122 and the FPC 175, and sends the sense current (read current), write information, and read information. The suspension substrate 180 is welded with or fixed onto the suspension 179 at a welding part 179c on a surface onto which the magnetic head part 120 is mounted.

The suspension 180 includes a base 181, a turning part 182, a long tail 183, a joint terminal part 184 at the tip of the long tail 183, and a main terminal part 165 connected to the joint terminal part 184 and the FPC 175.

One end of the base 181 is a wiring part (not shown) connected to the magnetic head part 120, and the other end of the base 181 is located near the boundary between the suspension 179 and the base plate 178. The base 181 extends from the magnetic head part 120 along the centerline of the suspension 179 in a longitudinal direction that is parallel to the longitudinal direction of the base plate 178.

The turning part 182 turns by 90° from the end of the base 181 to the outside of the arm, i.e., in a horizontal direction perpendicular to the longitudinal direction. The other end of the turning part 182 turns by about 90° on a side surface of the arm 176.

The long tail 183 starts from the other end of the turning part 182, and ends at the connection part with the FPC 175 or the main terminal part 185 via the joint terminal part 184, extending along the side surface of the arm 176. The suspension substrate 180 that includes the long tail 183 is provided with a wiring pattern on a substrate via an insulating layer, such as polyimide. The substrate is made, for example, of SUS, and its rigidity is high or it is substantially rigid.

This embodiment thus uses a long tail suspension having the long tail 183, which extends a suspension substrate that is electrically connected to the head and provided on the surface of the suspension, whereby an end of the suspension substrate is directly connected to the FPC as a preamplifier fixed onto the carriage. The long tail suspension integrates a conventional trunk FPC that connects the main FPC to the suspension board, with the suspension substrate for impedance matching.

The terminal parts 184 and 185 are soldered with the main FPC 175 after being bent by 90° around the longitudinal direction of the long tail 183. The terminal part 185 has a pair of terminals for recording and a pair of terminals for reproducing for the head 122. The terminal part 185 of another embodiment further has a pair of terminals for floatation amount control.

In operation of the HDD 100, the spindle motor 106 rotates the disc 104. The airflow associated with the rotations of each disc 104 is introduced between the disc 104 and slider 121, forming a fine air film and thus generating the floating force that enables the slider 121 to float over the disc surface. The suspension 179 applies an elastic compression force to the slider 121 in a direction opposing to the floating force of the slider. As a result, a balance between the floating force and the elastic force is formed.

The balance between the floating force and the elastic force spaces the magnetic head part 120 from the disc 104 by a certain distance. Next, the carriage 170 rotates around the shaft 174 for the head's seek for a target track on the disc 104. In writing, data from a host (not shown) such as a PC through an interface is modulated and supplied to the inductive head device 130. Thereby, the inductive head device 130 writes down the data onto the target track. In reading, the MR head device 140 is supplied with the predetermined sense current, and reads desired information from the target track on the disc 104. This embodiment selects the MR head device 140 that is durable to the external load, stabilizing the reading action of the HDD 100.

Further, the present invention is not limited to these preferred embodiments, and various variations and modifications may be made without departing from the scope of the present invention. For example, the present invention is applicable, in addition to a magnetic head, to a magnetic sensor, such as a magnetic potentiometer that detects a displacement and an angle, reading of a magnetic card, and recognition of a paper bill printed in magnetic ink.

What is claimed is:

1. A method for inspecting a magnetic read/write head in which a magnetic recording part and a magnetic reproducing part are close to each other, said method comprising the steps of:
performing a magnetic recording operation with a load greater than a normal magnetic recording operation for the magnetic recording part; and
inspecting the magnetic reproducing part after the magnetic recording operation with the load.

2. A method according to claim 1, wherein said inspecting step inspects the voltage of the magnetic reproducing part when a constant current is flowed in the magnetic reproducing part.

3. A method according to claim 1, wherein the load is to flow current greater than rated current to be flowed in the magnetic recording part.

4. A method according to claim 1, wherein the load is to continuously write of a maximum write frequency.

5. A method according to claim 1, wherein the load is to continuously write for at least one round of a magnetic recording medium to be recorded and reproduced by the magnetic read/write head.

6. A test method of a read device of a head that includes the read device that reads information from a disc, and a write device that writes the information in the disc, said test method comprising the step of detecting a read characteristic of the read device while the write device applies a load to the read device before the head is mounted on a storage.

7. A method for manufacturing a storage that includes a head that includes the read device that reads information from a disc, and a write device that writes the information in the disc, said method comprising the steps of:
detecting a read characteristic of the read device while the write device applies a load to the read device before the head is mounted on the storage;
determining whether the read characteristic of the read device detected by said detecting step falls within a permissible range; and
selecting as a candidate to be mounted onto the storage the read device having the read characteristic that falls within the permissible range.

8. A manufacturing method according to claim 7, wherein the load is a magnetic load or a thermal load.

9. A manufacturing method according to claim 7, wherein said detecting step sets at least one of a magnitude of current to be flowed in the write device, a frequency of the current, and the number of writes to a value greater than a maximum value in an actual use mode used to actually write the information in the disc.

10. A manufacturing method a storage that includes a head that includes the read device that reads information from a disc, and a write device that writes the information in the disc, said method comprising:
a first detecting step of detecting a read characteristic of the read device under no load applied by the write device to the read device before the head is mounted on the storage;
a second detecting step of detecting the read characteristic of the read device under a load applied by the write device to the read device before the head is mounted on the storage;
determining whether a deterioration of the read characteristic of the read device detected by said second detecting step relative to the read characteristic of the read device detected by said first detecting step falls within a permissible range; and
selecting as a candidate to be mounted onto the storage the read device having the read characteristic that falls within the permissible range.

11. A manufacturing method according to claim 10, wherein the load is a magnetic load or a thermal load.

12. A manufacturing method according to claim 10, wherein said second detecting step sets at least one of a magnitude of current to be flowed in the write device, a frequency of the current, and the number of writes to a value greater than a maximum value in an actual use mode used to actually write the information in the disc.

13. A program that enables a computer to implement a manufacturing method of a storage that includes a head that includes the read device that reads information from a disc, and a write device that writes the information in the disc, said manufacturing method comprising the steps of:
determining whether a deterioration of the read characteristic of the read device under a load applied by the write device to the read device to the read characteristic under no load applied by the read device falls within a permissible range; and
outputting a determination result by said determining step while correlating the determination result with an identification of the head.

14. A testing machine of a head that includes the read device that reads information from a disc, and a write device that writes the information in the disc, said testing machine comprising:
a first mode used to detect a read characteristic of the read device under no load applied by the write device before the head is mounted on the storage;
a second mode used to detect a write characteristic of the write device before the head is mounted on the storage; and
a third mode used to detect the read characteristic of the read device under a load applied by the write device to the read device before the head is mounted on the storage;

15. A testing machine according to claim 14, further comprising a controller that determines whether a deterioration of the read characteristic of the read device under the load applied by applied by the write device to the read device to the read characteristic of the read device under no load applied by the write device falls within a permissible range before the head is mounted onto the storage.
